(19) United States
(12) Patent Application Publication
(10) Pub. No.: US 2013/0213788 A1
(43) Pub. Date: Aug. 22, 2013

(54) TOUCH PANEL

(71) Applicant: PANASONIC CORPORATION, (US)

(72) Inventors: Koji TANABE, Osaka (JP); Keishiro MURATA, Kyoto (JP)

(73) Assignee: PANASONIC CORPORATION, Osaka (JP)

(21) Appl. No.: 13/762,886

(22) Filed: Feb. 8, 2013

(30) Foreign Application Priority Data
Feb. 17, 2012 (JP) 2012-032323
Feb. 17, 2012 (JP) 2012-032324
Mar. 19, 2012 (JP) 2012-061454
Oct. 4, 2012 (JP) 2012-221982

(51) Int. Cl. H01H 1/029

(52) U.S. Cl. CPC H01H 1/029
USPC 200/600

(57) ABSTRACT

A touch panel includes a light-transmittable first conductive layer and a light-transmittable second conductive layer facing the first conductive layer with a predetermined gap between the conductive layers. At least one of the first and second conductive layers contains light-transmittable resin, metal filaments dispersed in the resin, and materials absorbing light reflected by the metal filaments. The touch panel allows a display of a display element on a rear surface to be easily viewed and is operated reliably.

### FIELD OF THE INVENTION

The present invention relates to a touch panel mainly used in operation of various electronic devices.

### BACKGROUND OF THE INVENTION

In recent years, with advance in functionality and diversification of various electronic devices, such as mobile phones or electronic cameras, in many electronic devices, light-transmittable touch panels are mounted on front surfaces of display elements, such as liquid crystal display elements. Operators operate the devices by touching the touch panels with her/his fingers while viewing displays of display elements on rear surfaces through the touch panels to switch various functions of the devices. There is a demand for electronic devices in which displays of display elements on rear surfaces can be easily viewed so as to reliably perform operations.

FIGS. 18 and 19 are a sectional view and an exploded perspective view of conventional touch panel 500 described in Japanese Patent Laid-Open Publication No. 2011-146023. Substrate 1 is a film-like light-transmittable substrate. Conductive layer 2 contains light-transmittable resin 2A and metal filaments 2B dispersed in resin 2A. Conductive layer 2 is light-transmittable and has substantially a strip shape. Conductive layers 2 are formed on an upper surface of substrate 1 and arranged in forward and backward directions.

Electrodes 3 are made of conductive material, such as silver, carbon, or copper foil. One ends of electrodes 3 are connected to one ends of conductive layers 2, respectively, while another ends of conductive layers 3 extend to a right end of a periphery of substrate 1. Electrodes 3 extend in a lateral direction perpendicular to conductive layer 2.

Substrate 4 has a film shape and is light-transmittable substrate similarly to substrate 1. Conductive layer 5, similarly to conductive layer 2, contains light-transmittable resin 5A and metal filaments 5B dispersed in resin 5A. Conductive layer 5 is light-transmittable and has substantially a strip shape. Conductive layers 5 are arranged on an upper surface of substrate 4 in the lateral direction perpendicular to conductive layer 2.

Electrode 6 is made of conductive material, such as silver, carbon, or copper foil, similarly to electrode 3. One ends of electrodes 6 are connected to ends of the conductive layers 5, respectively while another ends of conductive layers 5 extend to the right end of the periphery of substrate 4. Electrodes 6 extend in the lateral direction parallel with conductive layer 5.

Cover substrate 7 is a film-like light-transmittable substrate. Substrate 1 is stacked on the upper surface of substrate 4. Cover substrate 7 is stacked on the upper surface of substrate 1. The substrates are bonded to each other with adhesive agent, thereby constituting touch panel 500.

Touch panel 500 is mounted onto a front surface of a display element, such as a liquid crystal display, thus being installed into an electronic device. Electrodes 3 and 6 extending to the right end of the periphery are electrically connected to an electric circuit of the device with, e.g. a flexible wiring board or a connector.

The display element is mounted onto a rear surface of touch panel 500. While a voltage is applied from the electronic circuit sequentially to the electrodes 3 and 6, when the upper surface of cover substrate 7 is operated by being touched with a finger according to a display of the display element, a capacitance between conductive layers 2 and 5 changes at a position where the operation is performed. The position where the operation is performed by the change is detected by the electronic circuit, and various functions of the electronic device are switched.

For example, while menus are displayed on the display element, when an operator touches the upper surface of cover substrate 7 on a desired menu with her/his finger, an electric charge is lead to the finger to change a capacitance between conductive layers 2 and layer 5 at the position where the operation is performed. The change is detected by the electronic circuit to select the desired menu.

### SUMMARY OF THE INVENTION

A touch panel includes a light-transmittable first conductive layer and a light-transmittable second conductive layer facing the first conductive layer with a predetermined gap between the conductive layers. At least one conductive layer of the first and second conductive layers contains light-transmittable resin, metal filaments dispersed in the resin, and a material absorbing light reflected by the metal filaments. Alternatively, the conductive layer may contain beaded assemblies each made of metal particles instead of the metal filaments and the above materials dispersed in the resin.

The touch panel allows a display of a display element on a rear surface to be easily viewed and is operated reliably.

### BRIEF DESCRIPTION OF DRAWINGS

FIG. 1A is a plan view of a touch panel according to an exemplary embodiment.

FIG. 1B is a sectional view of the touch panel at line 1B-1B shown in FIG. 1A.

FIG. 2 is an exploded perspective view of the touch panel shown in FIG. 1B.

FIG. 3 is an enlarged sectional view of a conductive layer of the touch panel shown in FIG. 1B.

FIG. 4 is an enlarged sectional view of another conductive layer of the touch panel shown in FIG. 1B.

FIG. 5 is an enlarged sectional view of still another conductive layer of the touch panel shown in FIG. 1B.

FIG. 6 is a sectional view of another touch panel according to the embodiment.

FIG. 7 is an enlarged view of a beaded assembly which is made of metal particles and is dispersed in a conductive layer of the touch panel shown in FIG. 6.

FIGS. 8A to 8C are enlarged views of a beaded assembly of the touch panel shown in FIG. 6 for illustrating a method of manufacturing the touch panel, particularly illustrating processes for forming the beaded assembly.

FIG. 9 is a sectional view of a further touch panel according to the embodiment.

FIG. 10A is an enlarged sectional view of a conductive layer of the touch panel shown in FIG. 9.

FIG. 10B is an enlarged sectional view of a further touch panel according to the embodiment.

FIG. 11 is a sectional view of a further touch panel according to the embodiment.

FIGS. 12A to 12D are partial sectional views of the touch panel shown in FIG. 6 for illustrating a method of manufacturing the touch panel.

FIG. 13 is a sectional view of a further touch panel according to the embodiment.

FIG. 14A is a plan view of a further touch panel according to the embodiment.

FIG. 14B is a sectional view of the touch panel at line 14B-14B shown in FIG. 14A.

FIG. 15 is a plan view of a further touch panel according to the embodiment.

FIG. 16 is a plan view of a further touch panel according to the embodiment.

FIG. 17 is a plan view of a further touch panel according to the embodiment.

FIG. 18 is a sectional view of a conventional touch panel.

FIG. 19 is an exploded perspective view of the conventional touch panel.

### DETAILED DESCRIPTION OF PREFERRED EMBODIMENT

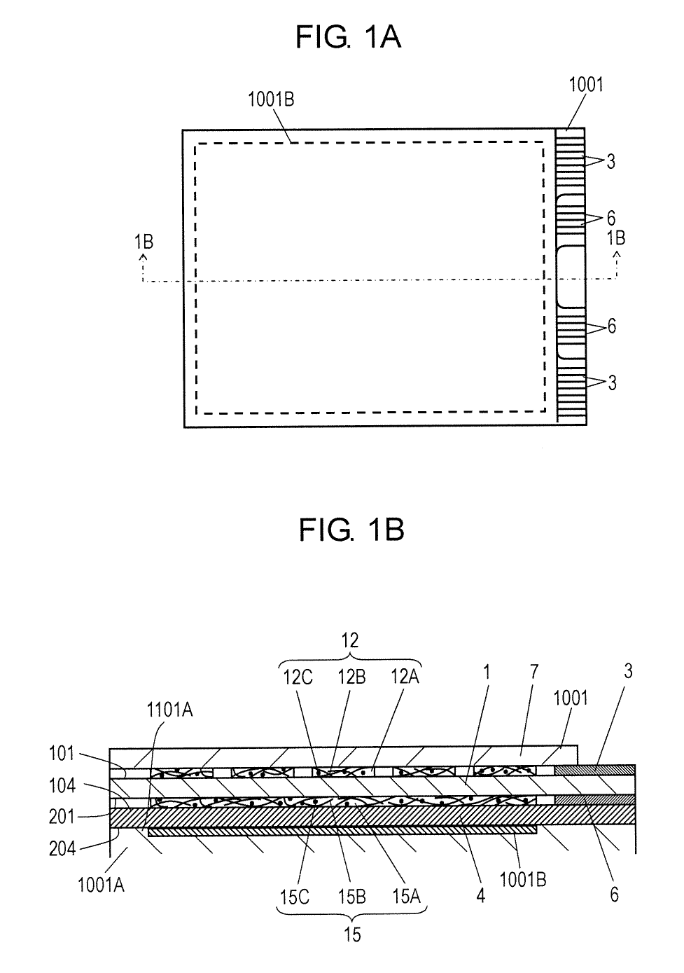

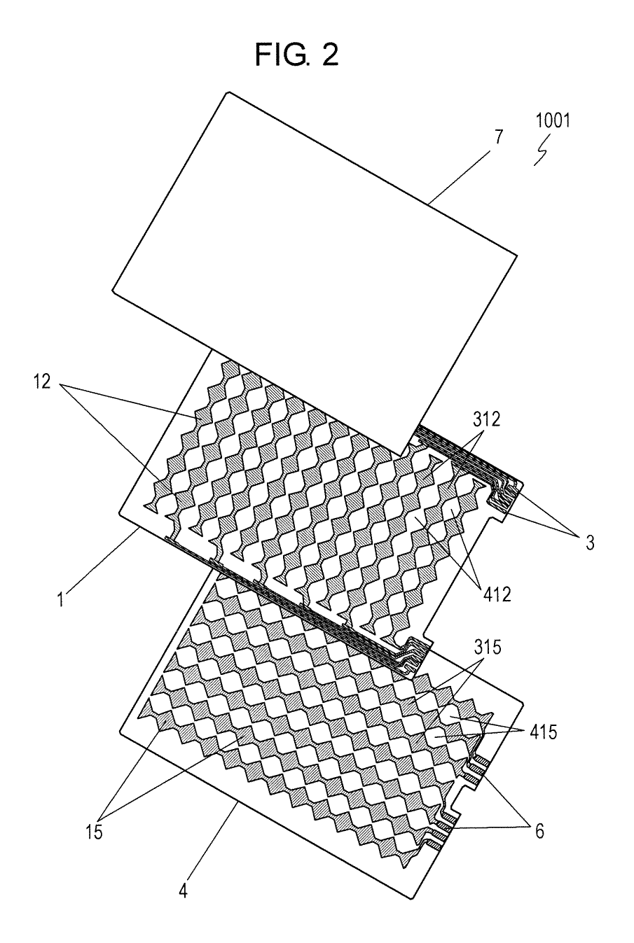

FIG. 1A is a plan view of touch panel 1001 according to an exemplary embodiment. FIG. 1B is a sectional view of touch panel 1001 at line 1B-1B shown in FIG. 1A. FIG. 2 is an exploded perspective view of touch panel 1001. Substrate 1 is a light-transmittable film made of, e.g. polyethylene terephthalate, polyethersulfone, or polycarbonate. Conductive layers 12 (first conductive layer) is light-transmittable and has substantially a strip shape. Conductive layers 12 are arranged on upper surface 101 of substrate 1 in forward and backward directions.

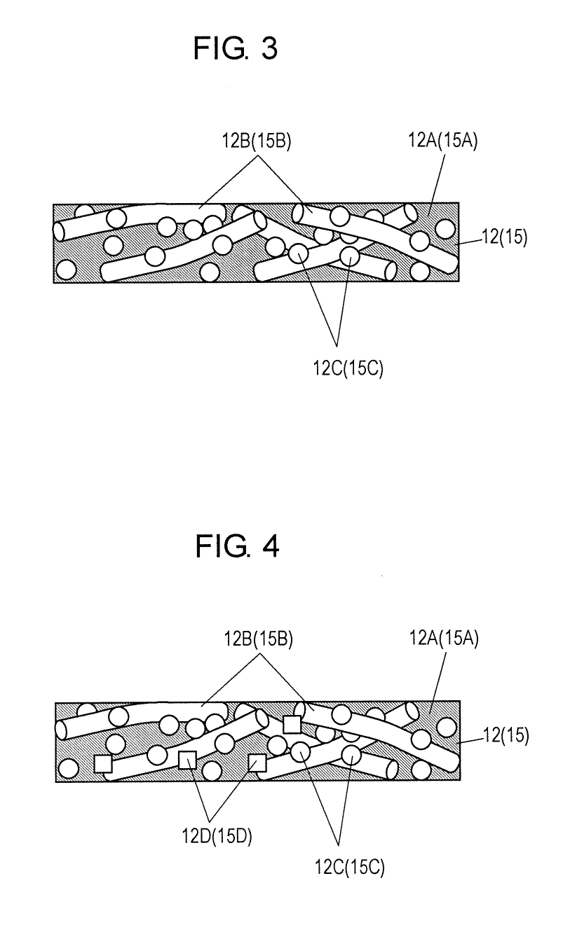

FIG. 3 is an enlarged sectional view of conductive layer 12 and conductive layer 15 (second conductive layer). Conductive layer 12 has a thickness ranging from about 0.1 μm to 20 μm, and contains insulating resin 12A, such as a light-transmittable acrylic resin, metal filaments 12B dispersed in resin 12A, and fine metal particles 12C dispersed in resin 12A. Metal filaments 12B have diameters ranging from about 10 nm to 300 nm and lengths ranging from about 1 μm to 100 μm. Fine metal particles 12C have an average particle diameter ranging from about 5 nm to 200 nm. Metal filament 12B is made of silver according to the embodiment, but may be made of other metals, such as copper alloy. Fine metal particles 12C is made of metal, such as silver, copper, gold, or platinum, having a positive standard electrode potential. Fine metal particles 12C aggregate at surfaces of metal filaments 12B and at intersections where metal filaments 12B cross each other.

Electrodes 3 are made of conductive material, such as silver or carbon, formed by printing or metal foil formed by deposition or the like. One ends of electrodes 3 are connected to ends of conductive layers 12, respectively, while another ends of electrodes 3 extend to a right end of a periphery of substrate 1. The electrodes 3 extend in lateral directions perpendicular to conductive layer 12.

Substrate 4 is a light-transmittable film, similarly to substrate 1. Conductive layers 15, similarly to conductive layers 12, contains light-transmittable resin 15A, metal filaments 15B dispersed in resin 15A, and fine metal particles 15C dispersed in resin 15A. Conductive layers 15 have substantially a strip shaped and are light-transmittable. Metal filament 15B is made of silver according to the embodiment, but may be made of other metals, such as copper alloy. Fine metal particles 15C is made of metal, such as silver, copper, gold, or platinum, having a positive standard electrode potential. Fine metal particles 15C aggregate at surfaces of metal filaments 15B and at intersections where metal filaments 15B cross each other. Conductive layers 15 are arranged on upper surface 104 of substrate 4 in the lateral direction perpendicular to conductive layers 12.

Electrode 6 is made of conductive material, such as silver, carbon, or copper foil, similarly to electrodes 3. One ends of electrodes 6 are connected to ends of conductive layers 15, respectively, while another ends of electrodes 6 extend to the right end of the periphery of substrate 4. Electrodes 6 extend in a lateral direction parallel with conductive layers 15.

Conductive layer 12 includes square portions 312 connected to each other to form the strip shape. Gaps 412 having substantially a square shape are provided between square portions 312. Conductive layer 15 includes square portions 315 connected to each other to form the strip shape. Gaps 415 having substantially a square shape are provided between square portions 315. While substrate 1 overlaps substrate 4, square portions 312 of conductive layers 12 overlaps gaps 415 of conductive layers 15, and gaps 412 of conductive layers 12 overlap square portions 315 of conductive layers 15.

Cover substrate 7 is a light-transmittable film made of light-transmittable material., such as polyethylene terephthalate, polycarbonate, or norbornene-based resin. Lower surface 201 of substrate 1 is stacked on upper surface 104 of substrate 4, and cover substrate 7 is stacked on upper surface 101 of substrate 1. The substrates are bonded to each other with adhesive agent, such as rubber cement or acrylic adhesive agent, thereby constituting touch panel 1001.

In touch panel 1001 according to the embodiment, conductive layers 12 arranged in the forward and backward direction face conductive layers 15 arranged in the lateral direction perpendicular to conductive layers 12 across substrate 1 with the predetermined gap.

A method of manufacturing conductive layers 12 and 15 will be described below. Resin 12A having metal filaments 12B and fine metal particles 12C dispersed therein is prepared. Resin 15A having metal filaments 15B and fine metal particles 15C dispersed therein is prepared. Then, resins 12A and 15A are formed substantially entirely on upper surfaces 101 and 104 of substrates 1 and 4, respectively by, e.g. printing, or application. Positions of surfaces of resins 12A and 15A to become conductive layers 12 and 15 are masked with insulating resin. Then, substrates 1 and 4 are immersed in etchant, such as aqua-regia-based, iron-chloride-based, or mixed-acid-based etchant diluted with water or the like, to remove unnecessary portions of metal filaments 12B and 15B and fine metal particles 12C and 15C by dissolution to form conductive layers 12 and 15 having gaps 412 and 415 in between, respectively.

As shown in FIG. 1B, touch panel 1001 is arranged on upper surface 1101A of display element 1001A, such as a liquid crystal display, thus being installed into an electronic device. Upper surface 1101A of display element 1001A is bonded to lower surface 204 of substrate 4. Upper surface 1101A of display element 1001A has display screen 1001B that displays an image thereon. Conductive layers 12 and conductive layers 15 are located above display screen 1001B. An operator views an image of a menu or the like displayed on display screen 1001B through conductive layers 12 and 15 and substrate 1 and 4. Electrodes 3 and 6 extending to the right ends of the peripheries of substrates 1 and 4 are electrically connected to the electronic circuit of the electronic device with a connecting member, such as a flexible wiring board or a connector.

While the electronic circuit applies a voltage sequentially to electrodes 3 and 6, an operator touches the upper surface of cover substrate 7 with her/his finger according to a display on display screen 1001B of display element 1001A, and changes a capacitance between conductive layers 12 and 15 locally at the touched position. The electronic circuit detects the touched position based on the change of the capacitance, and switches various functions of the electronic device.

For example, while menus are displayed on display element 1001A, the operator touches the upper surface of cover substrate 7 on a desired menu with her/his finger. When the upper surface is touched with the finger, an electric charge is lead to the finger, and a capacitance between conductive layers 12 and 15 of touch panel 1001 at the touched position. The electronic circuit detects the change and selects the desired menu.

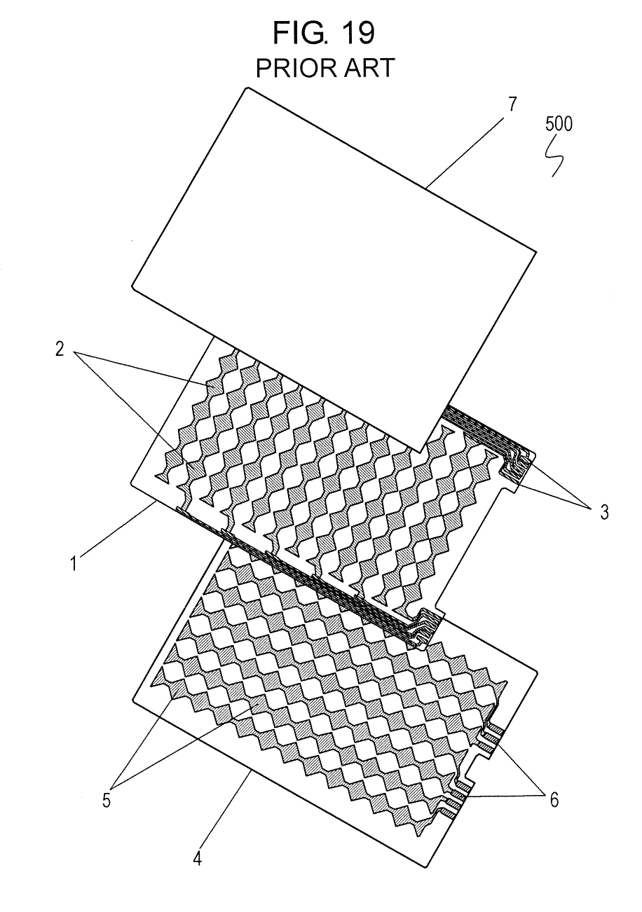

In conventional touch panel 500 shown in FIGS. 18 and 19, since conductive layer 2 and 5 are made of light-transmittable resins 2A and 5A having metal filaments 2B and 5B dispersed therein, a high light transmittance can be obtained, and the display of the display element can be easily viewed. However, when touch panel 500 is used under strong light, such as sunlight especially in outdoors, the light is diffusely reflected by metal filaments 2B and 5B and causes metal filaments 2B and 5B to look white, hence preventing and the operator from viewing the display of the display element easily.

In touch panel 1001 according to the embodiment, metal filaments 12B and fine metal particles 12C are dispersed in light-transmittable resin 12A of conductive layers 12, and metal filaments 15B and fine metal particles 15C are dispersed in light-transmittable resin 15A of conductive layers 15. When strong light, such as sunlight, is irradiated to touch panel 1001 in outdoors, the light diffusely reflected by metal filaments 12B and 15B is absorbed by fine metal particles 12C and 15C to prevent metal filaments 12B and 15B from looking white. This prevents the display of display element 1001A from hardly being viewed, thus allowing an operator to preferably visually recognize an image displayed on display screen 1001B of display element 1001A.

Fine metal particles 12C aggregate at surfaces of metal filaments 12B and at intersections where metal filaments 12B cross each other. Fine metal particles 15C aggregate at surfaces of metal filaments 15B and at intersections where metal filaments 15B cross each other. This structure reduces an entire resistance of conductive layers 12 and 15. The number of metal filaments 12B and 15B can be reduced accordingly, hence reducing diffused reflection of light by metal filaments 12B and 15B. This allows the display of display element 1001A to be easily viewed, accordingly allowing an operator to reliably operate the electronic device.

The resistance of the conductive layers containing 100 parts by weight of metal filaments 12B and 15B dispersed in resins 12A and 15A is almost equal to the resistance of the conductive layers containing 0.1 to 2 parts by weight of fine metal particles 12C and 15C and 80 to 95 parts by weight of metal filaments 12B and 15B dispersed in resins 12A and 15A.

When fine metal particles 12C and 15C absorb external light, touch panel 1001 exhibits yellow in the case that the average particle diameter of fine metal particles 12C and 15C ranges from about 5 nm to 20 nm. In the case that the average particle diameter ranges from about 30 nm to 60 nm, touch panel 1001 exhibits khaki. In the case that the average particle diameter ranges from about 70 nm to 200 nm, touch panel 1001 exhibits umber. Thus, touch panel 1001 may exhibit chromatic colors.

FIG. 4 is an enlarged sectional view of other conductive layers 12 and 15. In FIG. 4, components identical to those of conductive layers 12 and 15 shown in FIG. 3 are denoted by the same reference numerals. Conductive layer 12 shown in FIG. 4 further contains black substance 12D, such as dye or pigment, added into resin 12A, and conductive layer 15 further contain black substance 15D, such as dye or pigment, added into resin 15A. Black substances 12D and 15D convert the chromatic colors generated by fine metal particles 12C and 15C into achromatic colors, such as black, to prevent touch panel 1001 from being colored.

For example, in the case that the touch panel exhibits yellow due to fine metal particles 12C and 15C having an average particle diameter ranging from 5 nm to 20 nm, black substances 12D and 15D of blue and red color are added by dispersing blue and red black substances 12D and 15D in resins 12A and 15A to change the color of transmitted light from yellow into substantially achromatic color.

Fine metal particles 12C and 15C absorb external light, and black substances 12D and 15D absorb light diffusely reflected by metal filaments 12B and 15B, thereby reducing whiting to allow an operator to easily view the display of display element 1001A.

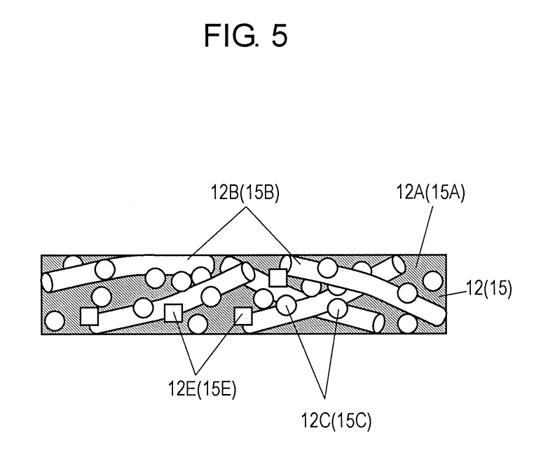

FIG. 5 is an enlarged sectional view of still another conductive layer 12 and still another conductive layer 15. In FIG. 5, components identical to those of conductive layers 12 and 15 shown in FIG. 4 are denoted by the same reference numerals. Conductive layer 12 shown in FIG. 5 further contains carbon particles 12E added into resin 12A instead of black substance 12D, and conductive layer 15 further contains carbon particles 15E added into resin 15A instead of black substance 15D. Carbon particles 12E and 15E provide the same effect as that of black substances 12D and 15D.

Fine metal particles 12C and 15C are made of material, such as silver, copper, gold, or platinum, having a positive standard electrode potential, prevents oxidation as in the case of metal having a negative standard electrode potential, thereby maintaining preferable conductivity of conductive layers 12 and 15.

In touch panel 1001 according to the embodiment, both conductive layers 12 and conductive layers 15 contain the resin (12A, 15A), metal filaments (12B, 15B) dispersed in resin (12A, 15A), and fine metal particles (12C, 15C) dispersed in resin (12A, 15A). Black substance (12D, 15D) may be added into both conductive layers 12 and 15. Alternatively, carbon particles (12E, 15E) may be dispersed in both conductive layers 12 and 15. In touch panel 1001 according to the embodiment, at least one of conductive layers 12 and conductive layers 15 may include light-transmittable conductive films made of, e.g. indium tin oxide or tin oxide instead of the resin, the metal filaments, and the fine metal particles. More specifically, in touch panel 1001 according to the embodiment, at least one of conductive layers 12 and conductive layers 15 contains resin (12A, 15A), the metal filaments (12B, 15B) dispersed in resin (12A, 15A), and the fine metal particles (12C, 15C) dispersed in resin (12A, 15A). Black substance (12D, 15D) may be added into at least one of conductive layer 12 and conductive layer 15. Alternatively, carbon particles (12E, 15E) may be dispersed in at least one of conductive layer 12 and conductive layer 15.

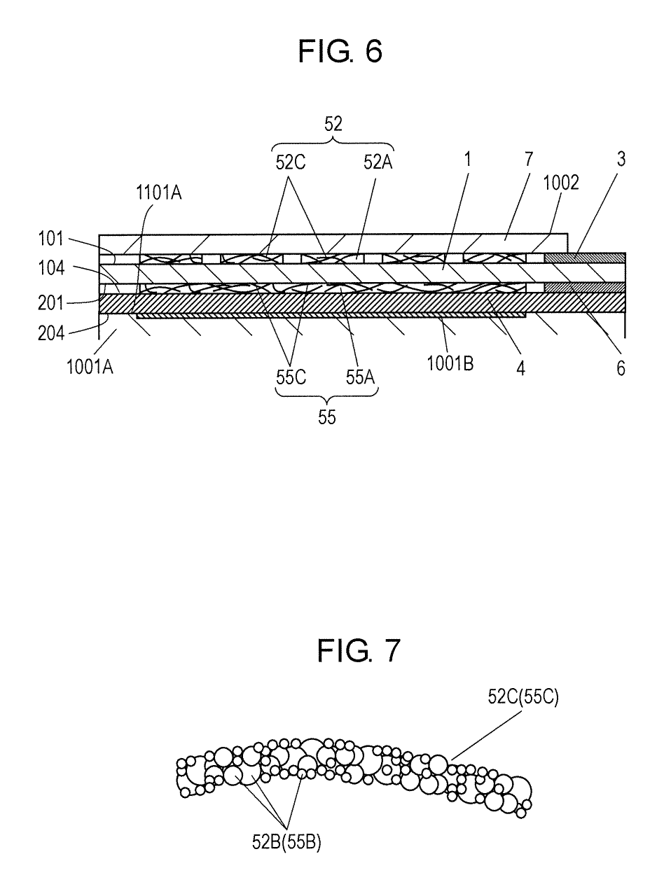

FIG. 6 is a sectional view of still another touch panel 1002 according to the embodiment. In FIG. 6, components identical to those of touch panel 1001 shown in FIGS. 1A to 3 are denoted by the same reference numerals. Touch panel 1002 shown in FIG. 6 includes, instead of conductive layers 12 and 15 of touch panel 1001 shown in FIGS. 1A to 3, light-transmittable conductive layers 52 and 55 having the same shapes as those of conductive layers 12 and 15.

Conductive layer 52 contains light-transmittable resin 52A, such as an acrylic resin, having a thickness ranging from about 0.1 μm to 20 μm and beaded assemblies 52C dispersed in resin 52A. Conductive layer 55 contains light-transmittable resin 55A, such as an acrylic resin having a thickness ranging from about 0.1 μm to 20 μm and beaded assemblies 55C dispersed in resin 55A.

FIG. 7 is an enlarged view of beaded assemblies 52C (55C). As shown in FIG. 7, beaded assembly 52C (55C) include metal particles 52B (55B) linked to each other to extend slenderly and having particle diameters of several nanometers to several hundred nanometers. Beaded assembly 52C (55C) has a diameter ranging from about 10 nm to 300 nm and a length ranging from about 1 μm to 100 μm. Metal particles 52B (55B) are made of silver according embodiment, but may be made of other metals, such as copper alloy.

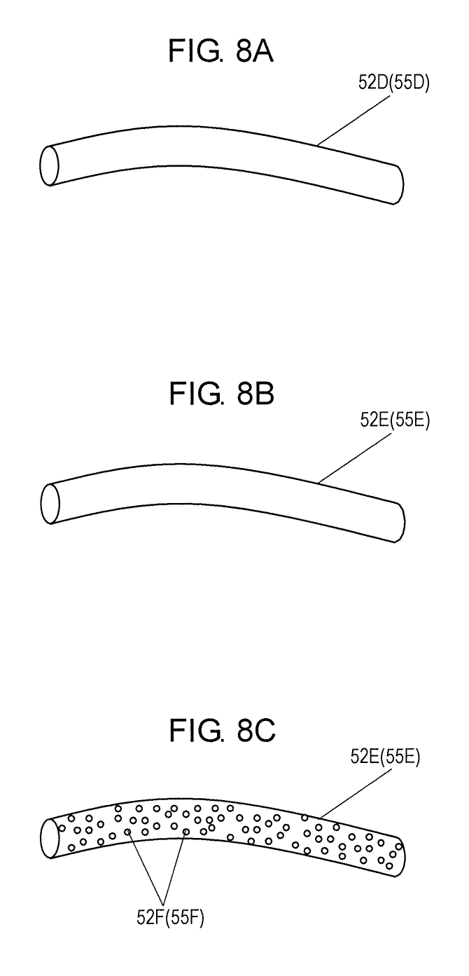

FIGS. 8A to 8C are enlarged sectional views of beaded assemblies 52C (55C) for illustrating a method of manufacturing conductive layer 52 (55), particularly processes of forming beaded assembly 52C (55C). Resin 52A (55A) having silver filaments 52D (55D) shown in FIG. 8A dispersed therein is formed on upper surface 101 (104) of substrate 1 (4). Then, substrate 1 (4) is immersed in 10% to 70% hydrochloric acid containing 0.01% to 5% of potassium permanganate added therein. Thus, metal filaments 52D (55D) on upper surface 101 (104) of substrate 1 (4) are halogenated to form silver chloride filaments 52E (55E) shown in FIG. 8B.

Then, ultraviolet rays are irradiated to silver chloride filaments 52E (55E) so as to form silver crystal cores 52F (55F) in silver chloride filaments 52E (55E), as shown in FIG. 8C. Then, silver chloride filaments 52E (55E) having silver crystal cores 52F (55F) are immersed in a reducing developer containing a reducer, such as metol, phenidone, or hydroquinone, to grow silver crystal cores 52F (55F), thereby forming resin 52A (55A) having beaded assemblies 52C (55C) dispersed therein by causing metal particles 52B (55B) made of silver to link to each other, as shown in FIG. 7.

Then, similarly to touch panel 1001 shown in FIGS. 1B and 2, beaded assemblies 52C and 55C at unnecessary positions are dissolved and removed to form conductive layers 52 and 55 facing each other a gap between layers 52 and 55.

Touch panel 1002, similarly to touch panel 1001 shown in FIG. 1B, is mounted on display element 1001A and used as shown in FIG. 6. In touch panel 1002, conductive layer 52 contains light-transmittable resin 52A and beaded assemblies 52C dispersed in resin 52A. Conductive layer 55 contains light-transmittable resin 55A and beaded assemblies 55C dispersed in resin 55A. Beaded assembly 52C (55C) includes metal particles 52B (55B) linked to each other. When strong light, such as sunlight, is irradiated onto touch panel 1002 in outdoors, the light is absorbed by metal particles 52B and 55B by converting the light into thermal energy, thereby preventing the light from being diffusely reflected by beaded assemblies 52C and 55C. Thus, the display of display element 1001A can be prevented from being hardly viewed, and an operator can preferably visually recognize an image displayed on display screen 1001B of display element 1001A.

In touch panel 1002 shown in FIG. 6, each of conductive layers 52 and 55 contains the resin (52A, 55A) and the beaded assemblies (52C, 55C) dispersed in the resin (52A, 55A). Each beaded assembly (52C, 55C) includes the metal particles (52B, 55B) linked to each other. One of conductive layers 52 and 55 may be made of light-transmittable conductive films made of, e.g. indium tin oxide or tin oxide instead of the resin and the beaded assemblies. At least one of conductive layers 52 and 55 contains the resin (52A, 55A) and the beaded assemblies (52C, 55C) dispersed in the resin (52A, 55A).

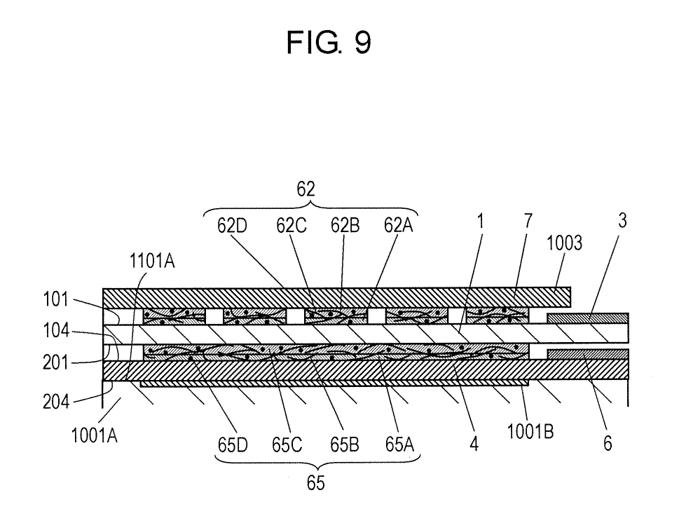

FIG. 9 is a sectional view of further touch panel 1003 according to the embodiment. In FIG. 9, components identical to those of touch panel 1001 shown in FIGS. 1A to 3 are denoted by the same reference numerals. Touch panel 1003 shown in FIG. 9 includes light-transmittable conductive layers 62 and 65 having the same shapes as conductive layers 12 and 15 instead of conductive layers 12 and 15 of touch panel 1001 shown in FIGS. 1A to 3

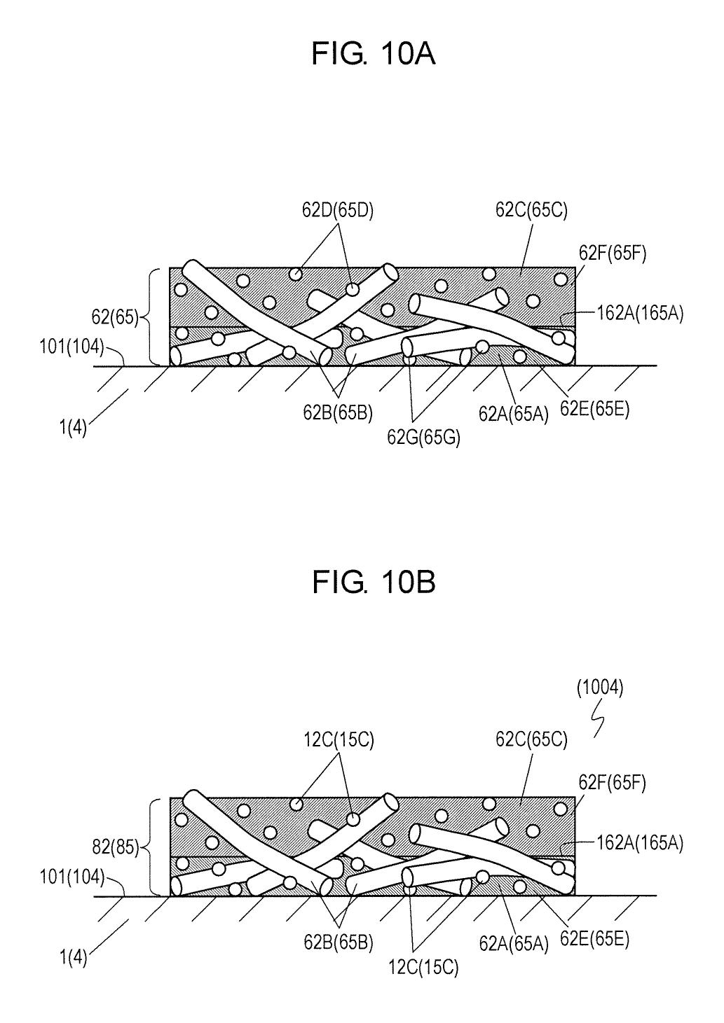

FIG. 10A is an enlarged sectional view of conductive layers 62 and 65. Conductive layer 62 includes undercoat layer 62A provided on upper surface 101 of substrate 1 and overcoat layer 62C provided on upper surface 162A of undercoat layer 62A. Undercoat layer 62A contains light-transmittable base material 62E, such as polyvinyl alcohol, and metal filaments 62B dispersed in base material 62E. Metal filament 62B has a diameter ranging from about 10 nm to 300 nm and a length ranging from about 1 μm to 100 μm. Overcoat layer 62C covers upper surface 162A of undercoat layer 62A, and is made of light-transmittable resin, such as an acrylic resin or an epoxy resin. Overcoat layer 62C contains metal filaments 62B as well as undercoat layer 62A. However, the density of the metal filaments 62B distributed in overcoat layer 62C is lower than the density of the metal filaments 62B distributed in undercoat layer 62A.

Undercoat layer 62A contains 0.00001% to 0.5% by weight, preferably, 0.001% to 0.01% by weight of black substance 62G, such as an acid dye, a direct dye, or a black pigment, added therein. Overcoat layer 62C contains 0.00001% to 0.5% by weight, preferably, 0.001% to 0.01% by weight of black substances 62D, such as a nigrosin-based dye, an azine-based dye, or a black pigment, added therein.

Conductive layer 65 includes undercoat layer 65A provided on upper surface 104 of substrate 4 and overcoat layer 65C provided on upper surface 165A of undercoat layer 65A. Undercoat layer 65A contains light-transmittable base material 65E, such as polyvinyl alcohol, and metal filaments 65B dispersed in base material 65E. Metal filament 65B has a diameter ranging from about 10 nm to 300 nm and a length ranging from about 1 μm to 100 μm. Overcoat layer 65C covers upper surface 165A of undercoat layer 65A, and is made of a light-transmittable resin, such as an acrylic resin or an epoxy resin. Overcoat layer 65C contains metal filaments 65B as well as undercoat layer 65A. However, the density of the metal filaments 65B distributed in overcoat layer 65C is lower than the density of the metal filaments 65B distributed in undercoat layer 65A.

Undercoat layer 65A contains 0.00001% to 0.5% by weight, preferably, 0.001% to 0.01% by weight of black substance 65G, such as an acid dye, a direct dye, or a black pigment, added therein. Overcoat layer 65C contains 0.00001% to 0.5% by weight, preferably, 0.001% to 0.01% by weight of black substance 65D, such as a nigrosin-based dye, an azine-based dye, or a black pigment, added therein.

Base material 62E (65E) of undercoat layer 62A (65A) may be a resin, such as gelatin, acrylic acid resin, nylon resin, cellulose resin, or polyester resin. The resin of overcoat layer 62C (65C) may be, e.g. urethane resin, polyester resin, silicone resin, or polycarbonate resin.

A method of forming conductive layers 62 and 65 will be described below. Base material 62E having metal filaments 62B and black substance 62G dispersed therein is prepared. Base material 65E having metal filaments 65B and black substance 65G dispersed is prepared. Resin 62F having black substance 62D dispersed therein is prepared. Resin 65F having black substance 65D dispersed therein is prepared.

Base material 62E prepared as described above is formed substantially entirely on upper surface 101 of substrate 1 by, e.g. printing or application to form undercoat layer 62A. Then, resin 62F having black substance 62D dispersed therein is formed substantially entirely on upper surface 162A of undercoat layer 62A by, e.g. printing or application to form overcoat layer 62C.

Then, similarly to touch panel 1001 shown in FIGS. 1B and 2, a position on the upper surface of overcoat layer 62C to be conductive layer 62 is masked with an insulating resin, and then, substrate 1 is immersed in an etchant, such as an aqua-regia-based, iron-chloride-based, or mixed-acid-based etchant, diluted with water or the like to dissolve and remove metal filaments 62B at unnecessary positions. Thereby, conductive layers 62 having gaps between them are formed.

Similarly, base material 65E prepared as described above is formed substantially entirely on upper surface 104 of substrate 4 by, e.g. printing or application to form undercoat layer 65A. Then, resin 65F having black substance 65D dispersed therein is formed substantially entirely on upper surface 165A of undercoat layer 65A by, e.g. printing or application to form overcoat layer 65C.

Then, similarly to touch panel 1001 shown in FIGS. 1B and 2, a position on the upper surface of overcoat layer 65C to be conductive layer 65 is masked with an insulating resin, and then, substrate 4 is immersed in an etchant, such as an aqua-regia-based, iron-chloride-based, or mixed-acid-based etchant, diluted with water or the like to dissolve and remove metal filaments 65B at unnecessary positions. Thereby, conductive layers 65 having gaps between them are formed.

As described above, conductive layers 62 and 65 have a double-layer structure including undercoat layers 62A and 65A and overcoat layers 62C and 65C, respectively. This structure allows a small number of metal filaments 62B and 65B can increase a conductivity of conductive layers 62 and 65. That is, metal filaments 62B tangle with each other and contact each other to be connected electrically, and metal filaments 65B tangle with each other and contact each other to be connected electrically. The amounts of base materials 62E and 65E of undercoat layers 62A and 65A are much smaller than the amounts of metal filaments 62B and 65B so as to increase the densities of metal filaments 62B and 65B in surface directions to cause metal filaments 62B to contact each other and cause metal filaments 65B to contact each other, accordingly increasing the conductivity of undercoat layers 62A and 65A. After undercoat layers 62A and 65A are formed on substrate 1 and 4, respectively, undercoat layers 62A and 65A may be physically pressed with a roller. This pressing further allows metal filaments 62B and 65B to contact each other more securely. This pressing prevents metal filaments 62B and 65B from overlapping excessively in the thickness direction, thereby preventing metal filaments 62B and 65B from blocking light.

Overcoat layers 62C and 65C fix metal filaments 62B and 65B in undercoat layers 62A and 65A, and provides conductive layers 62 and 65 with reliability against the change of environmental factors, such as a temperature, humidity, and ambient gas. Overcoat layers 62C and 65C is formed by applying resins 62F and 65F which contain the black substance but do not contain metal filaments 62B and 65B, hence having thicknesses be adjusted precisely at a nano-meter order. Therefore, respective portions of metal filaments 62B and 65B can be exposed from overcoat layers 62C and 65C so as to connect conductive layers 62 and 65 as transparent conductive films securely electrically with electrodes 3 and 6, respectively.

Touch panel 1003 obtained as described above, similarly to touch panel 1001 shown in FIG. 1B, is mounted onto display element 1001A and used as shown in FIG. 9. In conductive layer 62, light-transmittable undercoat layer 62A containing metal filaments 62B dispersed therein is covered with light-transmittable overcoat layer 62C. In conductive layer 65, light-transmittable undercoat layer 65A having metal filaments 65B dispersed therein is covered with light-transmittable overcoat layer 65C. Furthermore, black substances 62G and 65G are added in undercoat layers 62A and 65A, and black substances 62D and 65D are added in overcoat layers 62C and 65C. Thus, even though touch panel 1003 is used under strong light, such as sunlight in outdoors, the display of display element 1001A is prevented from hardly being viewed by diffuse reflection by metal filaments 62B and 65B, thus allowing display element 1001A to be preferably viewed.

Black substances 62D, 62G, 65D, and 65G make undercoat layers 62A and 65A and overcoat layers 62C and 65C translucent, i.e., get into a so-called smoky outlook, thereby reducing incidence of external strong light, such as sunlight. Further, black substances 62D, 62G, 65D, and 65G absorb reflected light reflected by metal filaments 628 and 65B to reduce diffuse reflection. Even though the electronic device is used under the strong external light, the display of display element 1001A can be easily viewed, and an operator can reliably operate the electronic device.

Black substances 62D, 62G, 65D, and 65G per se are block substances of one type. However, not only the black substances but also black substances obtained by mixing red dyes, blue dyes, and yellow dyes with each other may also be used.

Instead of black substances 62D, 62G, 65D, and 65G, a black photochromic agent having a color changing depending on the amount of light may be added in undercoat layers 62A and 65A and overcoat layers 62C and 65C. In this case, when touch panel 1003 is used under strong external light, such as sunlight, undercoat layers 62A and 65A and overcoat layers 62C and 65C get into a translucently smoky state. On the other hand, when touch panel 1003 is used under weak light, such as interior light, undercoat layers 62A and 65A and overcoat layers 62C and 65C are kept transparent and do not get into a smoky outlook. Therefore, the display of display element 1001A can be easily viewed, and the electronic device can be more easily operated.

The photochromic agent per se may not be black. That is, when a photochromic agent is made of, for example, a diarylethene derivative, 1,2-bis(2-methylbenzo[b]thiophene-3-yl)perfluorocyclopentene serving as a red dye, 1,2-bis(2-methyl-5-phenyl-3-thienyl)perfluorocyclopentene serving as a blue dye, 1,2-bis(3-methyl-2-thienyl)perfluorocyclopentene serving as an yellow dye, are mixed to form a black photochromic agent.

Alternatively, hexaaryl bisimidazole serving as a red dye, 2-(4-aminophenyl)-2-alkyl-2H-naphtho[1,2-b]pyran serving as a blue dye, 3(2-fluorophenyl)-3(4-methoxyphenyl)-3H-naphtho[2,1-b]pyran serving as an yellow dye, may be mixed to obtain a black photochromic agent. A black chromic material may be made of a naphthopyran derivative, an oxazine derivative, a thyazole derivative, or an imidazole derivative.

In touch panel 1003 according to the embodiment, black substances 62D, 62G, 65D, and 65G or a black photochromic agent may be added in all undercoat layers 62A and 65A and overcoat layers 62C and 65C. Only one of undercoat layer 62A (65A) and overcoat layer 62C (65C) is added with a black substance without being added with a black photochromic agent, and only the other is added with the black photochromic agent and need not be added with the black substance. Alternatively, only one of undercoat layer 62A (65A) and overcoat layer 62C (65C) is added with both a black substance and a black photochromic agent, and the other need not be added with either the black substance or the black photochromic agent. Only one of undercoat layer 62A (65A) and overcoat layer 62C (65C) is added with a black substance without being added with a black photochromic agent, and the other may be added with neither the black photochromic agent nor the black substance. Alternatively, only one of undercoat layer 62A (65A) and overcoat layer 62C (65C) is added with a black photochromic agent without being added with a black substance, and the other is added with neither the black photochromic agent nor the black substance.

Conductive layers 12, 15, 52, 55 of touch panels 1001 and 1002 shown in FIGS. 1A to 8C may have the double-layer structure including undercoat layer 62A (65A) and overcoat layer 62C (65C) shown in FIG. 10A, thus providing the same effects.

FIG. 10B is an enlarged sectional view of further touch panel 1004 according to the embodiment. In FIG. 10B, components identical to those of touch panels 1001 and 1003 shown in FIGS. 3 and 10A are denoted by the same reference numerals. Touch panel 1004 includes conductive layers 82 and 85 instead of conductive layers 62 and 65 of touch panel 1003 shown in FIG. 10A. FIG. 10B illustrates conductive layers 82 and 85. Conductive layer 82 (85) contains metal fine particles 12C (15C) of touch panel 1001 shown in FIG. 3 instead of black substances 62D and 62G (65D and 65G) and the photochromic agent shown in FIG. 10A. Metal fine particles 12C (15C) are dispersed in base material 62E (65E) or resin 62F (65F). Conductive layer 82 (85) includes undercoat layer 62A (65A) and overcoat layer 62C (65C) which are made of the same structures and materials as those of touch panel 1003 shown in FIG. 10A and are formed by the same method as that of touch panel 1003, providing the same effects.

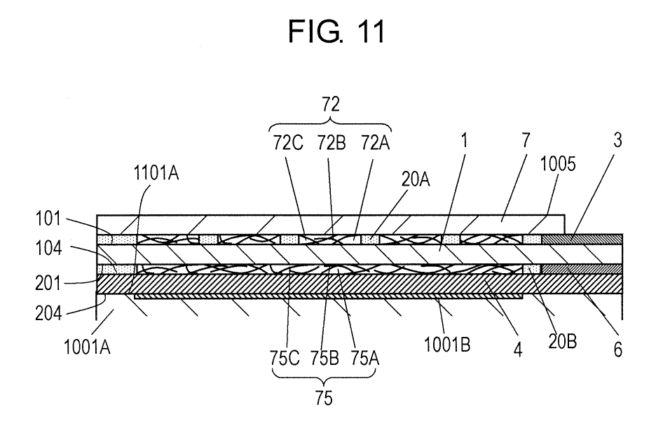

FIG. 11 is a sectional view of further touch panel 1005 according to the embodiment. In FIG. 11, components identical to those of touch panel 1001 shown in FIGS. 1A and 1B are denoted by the same reference numerals. Touch panel 1005 shown in FIG. 11 includes light-transmittable conductive layers 72 and 75 having the same shapes as conductive layers 12 and 15 of touch panel 1001 shown in FIGS. 1A and 1B instead of conductive layers 12 and 15.

Conductive layer 72 contains insulating light-transmittable resin 72A, metal filaments 72B dispersed in resin 72A, and carbon filaments 72C dispersed in resin 72A. Resin 72A is made of light-transmittable, photosensitive, ultra-violet photocrosslinkable resin, such as acrylate or methacrylate, or light-transmittable, photosensitive resin, such as oxabenznorbornadiene, isomerizing to be aqueous. Metal filaments 72B have diameters ranging from about 10 nm to 300 nm and lengths ranging from about 1 μm to 100 μm, and are made of metal, such as silver, copper, or copper-nickel alloy. Carbon filaments 72C have diameters ranging from about 0.5 nm to 50 nm and lengths ranging from about 0.5 μm to 10 μm, and made of, e.g. hollow carbon nanotube.

Conductive layer 75 contains resin 75A, metal filaments 75B, and carbon filaments 75C identical to resin 72A, metal filaments 72B, and carbon filaments 72C of conductive layer 72.

Substrates 1 and 4 and conductive layers 72 and 75 constitute conductive-layer sheets 14 and 18, respectively. Conductive-layer sheet 14 is adhered to an upper surface of conductive-layer sheet 18 with adhesive layer 20B while cover substrate 7 is adhered to an upper surface of conductive-layer sheet 14 with adhesive layer 20A. Adhesive layers 20A and 20B are made of light-transmittable adhesive, such as acrylic adhesive or epoxy adhesive. Adhesive layers 20A and 20B can be applied similarly to touch panels 1001 to 1004 shown in FIGS. 1 to 10B.

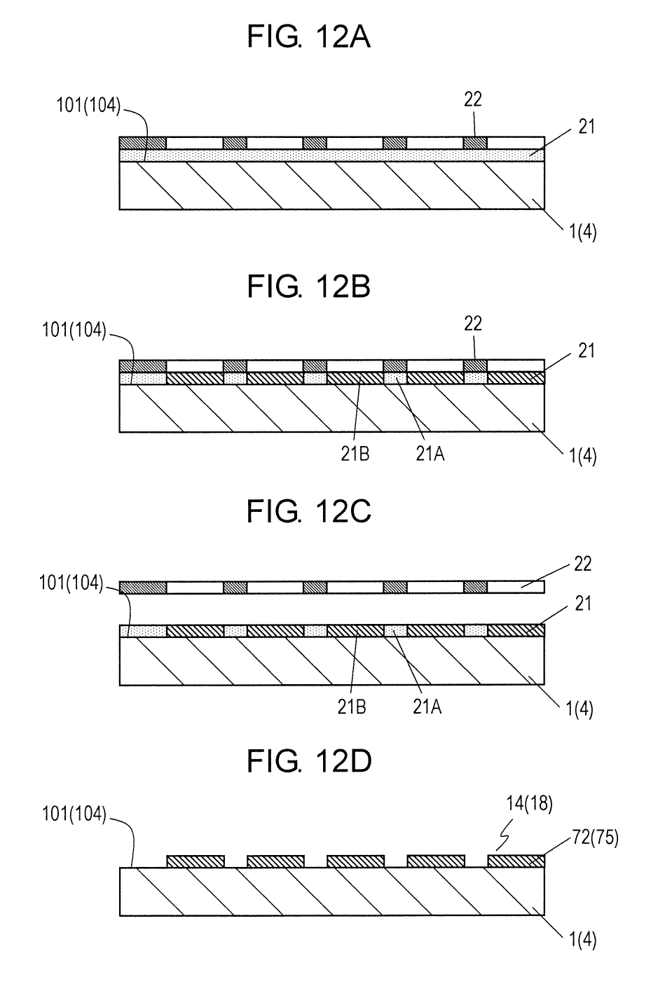

FIGS. 12A to 12D are partial cross-sectional views of touch panel 1005 for illustrating a method of manufacturing the touch panel, particularly, forming conductive layer 72 (75) on upper surface 101 (104) of substrate 1 (4). First, a conductive resin containing resin 72A (75A), metal filaments 72B (75B) dispersed in resin 72A (75A), and carbon filaments 72C (75C) is prepared. Then, as shown in FIG. 12A, the conductive resin is applied entirely onto upper surface 101 (104) of substrate 1 (4) to provide conductive film 21. Conductive film 21 is exposed to pattern and developed. At this moment, If resin 72A (75A) of conductive film 21 is made of ultra-violet photocrosslinkable resin, such as acrylate or methacrylate, portion 21A of conductive film 21 at positions where conductive layer 72 (75) is not formed is masked with pattern film 22.

Then, as shown in FIG. 12B, portion 21B of conductive film 21 exposed from pattern film 22 is irradiated with ultraviolet light to crosslink and cure portion 21B, and then, pattern film 22 is removed. After that, conductive film 22 is immersed and rinsed in an aqueous solution of, e.g. sodium carbonate or tetramethylammonium hydroxide to dissolve and remove unnecessary portion 21A which is not crosslinked, thereby providing conductive-layer sheet 14 (18) including conductive layers 72 (75) having strip shapes arranged on upper surface 101 (104) of substrate 1 (4).

If resin 72A (75A) of conductive film 21 is made of resin, such as oxabenznorbornadiene, isomerizing with ultraviolet light to be aqueous, contrary to the above, portion 21B to be conductive layer 72 (75) is masked with pattern film 22. Then, portion 21A other than portion 21B is irradiated with ultraviolet light to isomerizes to be aqueous. Then, pattern film 22 is removed, and conductive film 21 is immersed and rinsed in the aqueous solution, thereby forming conductive layers 72 (75) having strip shapes arranged on upper surface 101 (104) of substrate 1 (4).

In touch panel 1005 shown in FIG. 11, conductive later 72 (75) contains metal filaments 72B (75B) and carbon filaments 72C (75C) dispersed in photosensitive resin 72A (75A). When strong light, such as sunlight, is irradiated to touch panel 1005 in outdoors, the light diffusely reflected by metal filaments 72B (75B) to cause the conductive layer to look milky-white color. Conductive layer 72 (75) prevents the above coloring and prevents the display element 1001A behind the touch panel from being hardly viewed, thus allowing display element 1001A to be visibly recognized preferably.

That is, carbon filaments 72C (75C) dispersed in resin 72A (75A) absorbs the reflected light to reduce the diffusing reflection. The touch panel can be readily operated to allow the display element 1001A to be viewed easily even if being used under strong light in outdoors.

A smaller amount of metal filaments 72B and 75B increases resistances of conductive layers 72 and 75. A smaller amount of carbon filaments 72C and 75C decreases the effect reducing the white color. The amount of metal filaments 72B (75B) in conductive layer 72 (75) ranges preferably from 50 to 99.5 weight %.

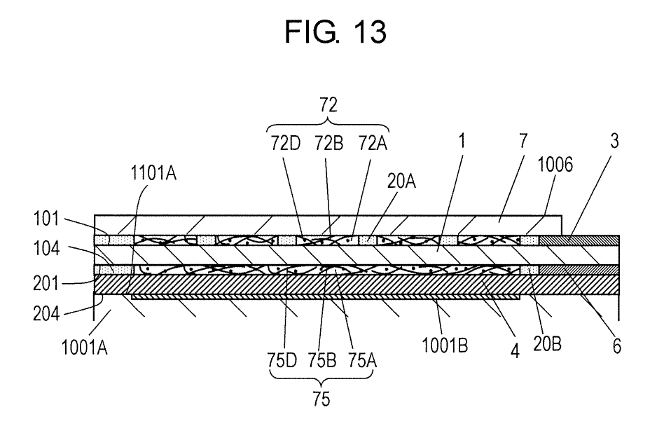

FIG. 13 is a sectional view of further touch panel 1006 according to the embodiment. In FIG. 13, components identical to those of touch panel 1005 shown in FIG. 11 are denoted by the same reference numerals. In touch panel 1006 shown in FIG. 13, conductive layer 72 (75) contains carbon particles 72D (75D) dispersed in photosensitive resin 72A (75A) instead of carbon filaments 72C (75C). That is, conductive layer 72 (75) of touch panel 1006 shown in FIG. 13 contains light-transmittable resin 72A (75A), metal filaments 72B (75B) dispersed in resin 72A (75A), and carbon particles 72D (75D) dispersed in resin 72A (75A). Carbon particles 72D (75D) have a primary particle diameters ranging from 2 nm to 100 nm.

Conductive layers 72 and 75 contains photosensitive resins 72A and 75A and metal filaments 72B and 75B and carbon particles 72D and 75D, respectively, while resins 72A and 75A is made of light-transmittable, photosensitive, ultra-violet photocrosslinkable resin, such as acrylate or methacrylate, or light-transmittable, photosensitive resin, such as oxabenznorbornadiene, isomerizing to be aqueous. These materials allow conductive layers 72 and 75 to be formed on upper surfaces 101 and 104 of substrates 1 and 4 just by the irradiating of ultraviolet light and the rinsing with the alkalescent aqueous solution without by an etching using strongly acidic solution, thus manufacturing conductive-layer sheets 14 and 18 easily.

Conductive layer 72 (75) and adhesive layer 20A (20B) may be formed on a removable sheet, and then, transferred onto the lower surface of cover substrate 7. This process allows touch panel 1006 to be thin and reduces the number of components of the panel. This transferring technique is applicable to the touch panels described above, providing the same effects.

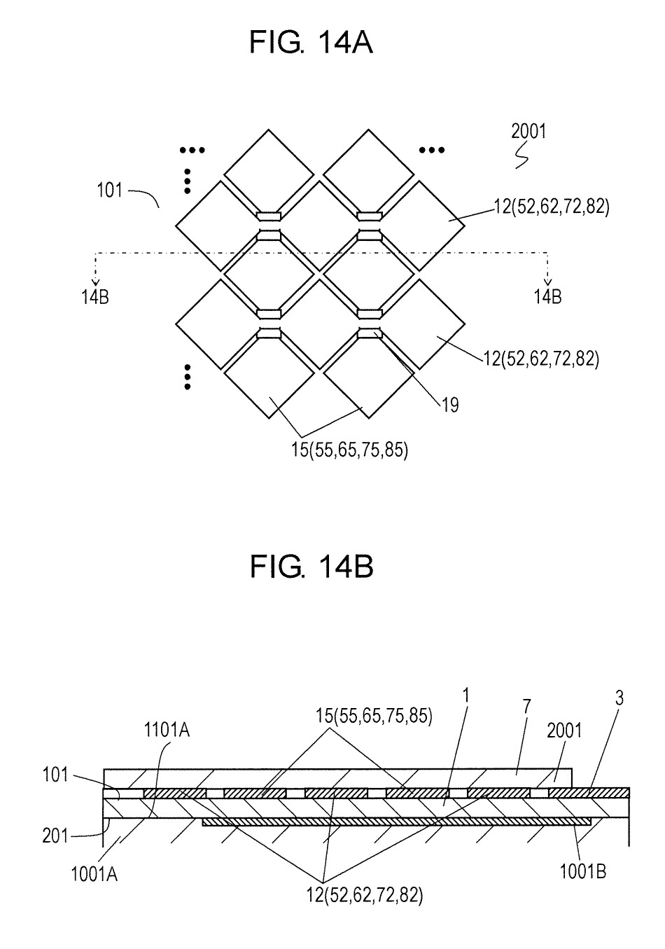

FIG. 14A is a plan view of further touch panel 2001 according to the embodiment, particularly illustrating the arrangement of conductive layer 12 (52, 62, 72, 82) and conductive layer 15 (55, 65, 75, 85). FIG. 14B is a cross-sectional view of touch panel 2001 at line 14B-14B shown in FIG. 14A. In FIGS. 14A and 14B, components identical to those of touch panels 1001 to 1006 shown in FIGS. 1A to 13 are denoted by the same reference numerals. In touch panels 1001 to 1006 shown in FIGS. 1A to 13, conductive layer 12 (52, 62, 72, 82) faces conductive layer 15 (55, 65, 75, 85) across substrate 1 in a direction perpendicular to upper surface 101 of substrate 1. In touch panel 2001 shown in FIGS. 14A and 14B, both of conductive layer 12 (52, 62, 72, 82) and conductive layer 15 (55, 65, 75, 85) are provided on upper surface 101 of substrate 1, and conductive layer 12 (52, 62, 72, 82) faces conductive layer 15 (55, 65, 75, 85) in a direction parallel to upper surface 101 of substrate 1.

Insulating layer 19 is provided between conductive layer 12 (52, 62, 72, 82) and conductive layer 15 (55, 65, 75, 85) at a portion where conductive layer 12 (52, 62, 72, 82) overlaps conductive layer 15 (55, 65, 75, 85) so as to electrically insulate conductive layer 12 (52, 62, 72, 82) from conductive layer 15 (55, 65, 75, 85). Touch panel 2001 does not include substrate 4, and can have a smaller thickness than touch panels 1001 to 1006 accordingly.

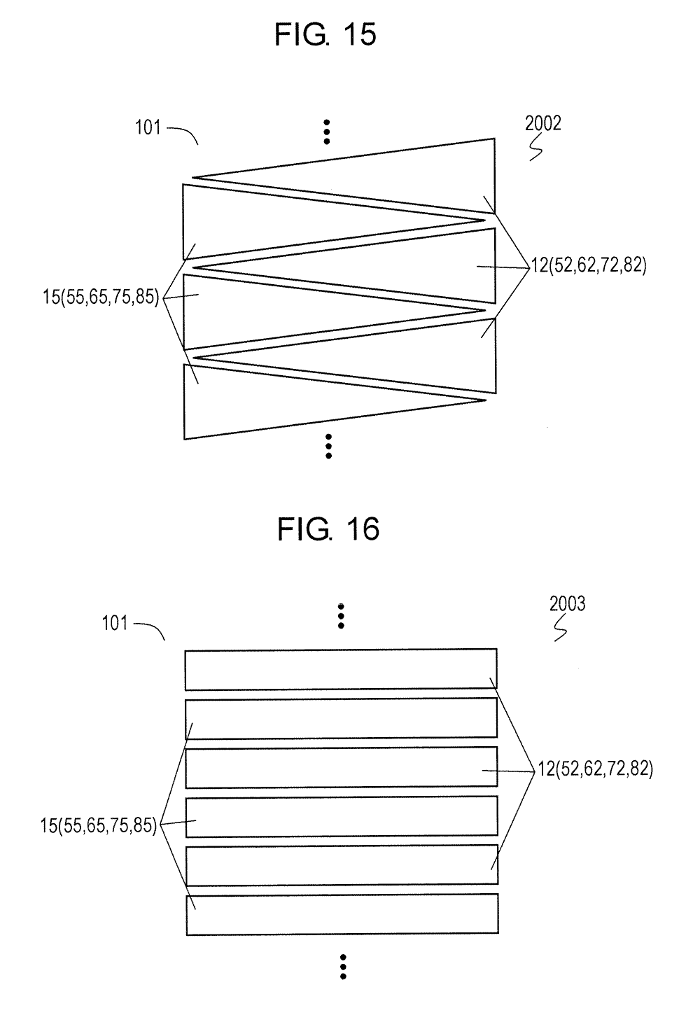

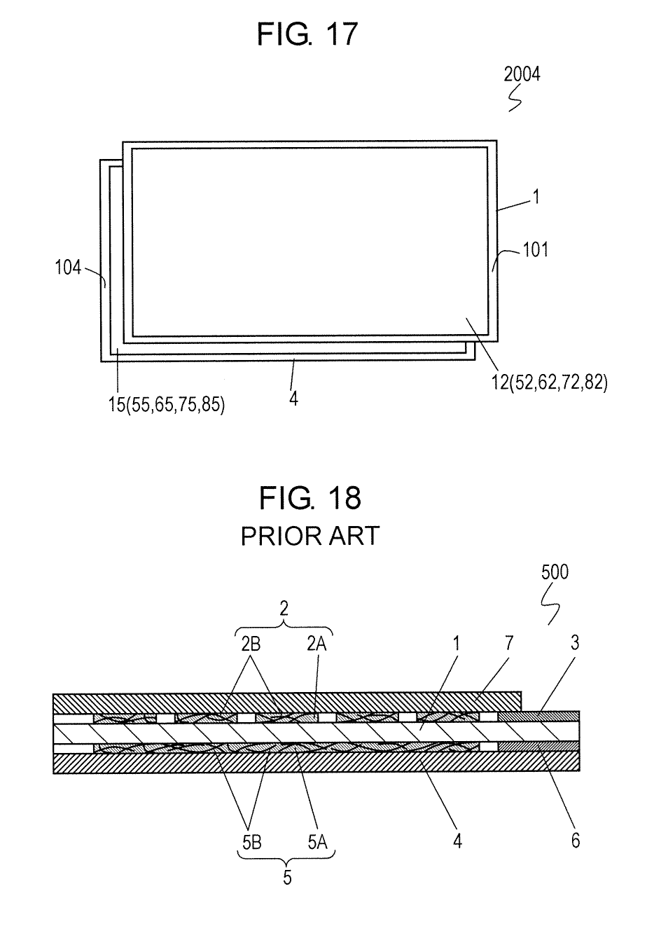

FIG. 15 is a plan view of further touch panel 2002 according to the embodiment. In FIG. 15, components identical to those of touch panels 2001 shown in FIG. 14A are denoted by the same reference numerals. In touch panel 2002 shown in FIG. 15, conductive layers 12 (52, 62, 72, 82) and 15 (55, 65. 75, 85) have elongate triangle shapes. In touch panel 2002 shown in FIG. 15, conductive layer 12 (52, 62. 72, 82) and conductive layer 15 (55, 65, 75, 85) are provided on upper surface 101 of substrate 1, and conductive layer 12 (52, 62, 72, 82) faces conductive layer 15 (55, 65, 75, 85) in directions parallel to upper surface 101 of substrate 1, similarly to touch panel 2001 shown in FIGS. 14A and 14B, providing the same effects.

FIG. 16 is a plan view of further touch panel 2003 according to the embodiment. In FIG. 16, components identical to those of touch panels 2002 shown in FIG. 15 are denoted by the same reference numerals. In touch panel 2002 shown in FIG. 15, conductive layers 12 (52, 62, 72, 82) and 15 (55. 65, 75, 85) have elongate rectangular shapes. In touch panel 2003 shown in FIG. 16, conductive layer 12 (52, 62, 72, 82) and conductive layer 15 (55, 65, 75, 85) are provided on upper surface 101 of substrate 1, and conductive layer 12 (52, 62, 72, 82) faces conductive layer 15 (55, 65, 75, 85) in directions parallel to upper surface 101 of substrate 1, similarly to touch panel 2002 shown in FIG. 15, providing the same effects.

In touch panels 1001 to 1006 according to the embodiment, substrate 4 is bonded to lower surface 201 of substrate 1. Substrate 1 and substrate 4 are turned upside down, and substrate 1 may be bonded to lower surface 204 of substrate 4. Alternatively, touch panels 1001 to 1006 do not necessarily include substrate 4, conductive layers 12 (52, 62, 72, 82) and 15 (55, 65, 75, 85) may be provided on upper surface 101 and lower surface 201 of substrate 1, respectively.

In the embodiment, terms, such as “upper surface” and “lower surface”, indicating directions indicate relative directions depending only on positional relationship of constituent components, such as the substrate and the conductive layer, of a touch panel, and do not indicate absolute directions, such as a vertical direction.

What is claimed is:

1. A touch panel comprising:
a first conductive layer being light-transmittable; and
a second conductive layer being light-transmittable and facing the first conductive layer with a predetermined gap between the first conductive layer and the second conductive layer,
wherein at least one of the first conductive layer and the second conductive layer contains resin being light-transmittable, metal filaments dispersed in the resin, and fine metal particles dispersed in the resin.

2. The touch panel according to claim 1, wherein the metal filaments comprise silver.

3. The touch panel according to claim 1, wherein the fine metal particles comprise metal having a positive standard electrode potential.

4. The touch panel according to claim 1, wherein the fine metal particles aggregate at surfaces of the metal filaments.

5. The touch panel according to claim 1, wherein the fine metal particles aggregate at an intersection where the metal filaments cross each other.

6. The touch panel according to claim 1, wherein said at least one of the first conductive layer and the second conductive layer includes:
a light-transmittable undercoat layer containing the resin and the metal filaments; and
an overcoat layer that covers the undercoat layer.

7. A touch panel comprising:
a first conductive layer being light-transmittable; and
a second conductive layer being light-transmittable and facing the first conductive layer with a predetermined gap between the first conductive layer and the second conductive layer,
wherein at least one of the first conductive layer and the second conductive layer contains light-transmittable resin and beaded assemblies dispersed in the resin, and
wherein each of the beaded assemblies is made of metal particles linked to each other to extend slenderly.

8. The touch panel according to claim 7, wherein the metal particles comprise silver.

9. A touch panel comprising:
a first conductive layer being light-transmittable; and
a second conductive layer being light-transmittable and facing the first conductive layer with a predetermined gap between the first conductive layer and the second conductive layer,
wherein at least one of the first conductive layer and the second conductive layer contains base material, metal filaments dispersed in the base material, and at least one of black substance and photochromic agent dispersed in the base material.

10. The touch panel according to claim 9, wherein said at least one of the first conductive layer and the second conductive layer includes:
a light-transmittable undercoat layer containing the base material and the metal filaments; and
an overcoat layer that covers the undercoat layer.

11. The touch panel according to claim 10, wherein said at least one of the black substance and the photochromic agent is provided in at least one of the undercoat layer and the overcoat layer.

12. The touch panel according to claim 9, wherein the black substance comprises carbon filaments.

13. The touch panel according to claim 9, wherein the black substance comprises carbon particles.
